(19) United States
(12) Patent Application Publication
(10) Pub. No.: US 2021/0231506 A1
(43) Pub. Date: Jul. 29, 2021

(54) TEMPERATURE SENSOR, TEMPERATURE MONITORING METHOD AND DEVICE THEREOF

(71) Applicants: Chengdu BOE Optoelectronics Technology Co., Ltd., Chengdu (CN); BOE Technology Group Co., Ltd., Beijing (CN)

(72) Inventor: Tiancheng Yu, Beijing (CN)

(21) Appl. No.: 17/051,516

(22) PCT Filed: Apr. 8, 2020
(86) PCT No.: PCT/CN2020/083739

§ 371 Date: Oct. 29, 2020

(30) Foreign Application Priority Data
Jun. 21, 2019 (CN) 201910543186.8

(51) Int. Cl. G01K 11/16; G01K 13/20

(52) U.S. Cl. CPC G01K 11/16; G01K 13/20

(57) ABSTRACT

A temperature sensor, a temperature monitoring method, and a temperature monitoring device are provided. The temperature sensor includes: at least one electroluminescent device, and a power supply device electrically coupled to the electroluminescent device. The power supply device is configured to provide a turn-on voltage of the electroluminescent device at a predetermined temperature to the electroluminescent device.

### CROSS-REFERENCE TO RELATED APPLICATION

This application is a Section 371 National Stage Application of International Application No. PCT/CN2020/083739, filed on Apr. 8, 2020, entitled “TEMPERATURE SENSOR, TEMPERATURE MONITORING METHOD AND DEVICE THEREOF” which claims priority to Chinese Patent Application No. 201910543186.8, filed on Jun. 21, 2019, the contents of which are incorporated herein by reference in their entireties.

### TECHNICAL FIELD

The present disclosure relates to a field of sensor technology, and particularly to a temperature sensor, a temperature monitoring method, and a temperature monitoring device.

### BACKGROUND

Temperature sensor is a kind of electronic components that are widely used in various fields and occasions where temperature measurement or overheat protection is required, such as medical treatment, automobiles, security and fire protection, home appliances, communications, etc. Especially, in the emerging new energy hybrid and electric vehicle fields, the temperature sensor is widely used to monitor a battery temperature, a motor temperature, an intake air temperature, and a cooling system temperature. In the related art of monitoring temperature with the temperature sensor, the most common application is to use a temperature sensor based on a negative temperature coefficient thermistor, where a resistance of the thermistor decreases as the temperature increases. In the case of monitoring temperature with the thermistor sensor, it is generally to provide a constant voltage, and also output a varying signal voltage when the resistance of the thermistor changes with the monitored temperature, so as to achieve the purpose of temperature measurement and further provide the overheat protection. The temperature sensor of the related art is used to monitor the environmental overheat protection temperature. When the monitored temperature exceeds the overheat protection temperature, the temperature sensor outputs an electrical signal and sends out a warning or alarm through a display terminal.

### SUMMARY

An embodiment of the present disclosure provides a temperature sensor, including: at least one electroluminescent device; and a power supply device electrically coupled to the electroluminescent device; wherein the power supply device is configured to provide a turn-on voltage of the electroluminescent device at a predetermined temperature to the electroluminescent device.

In an exemplary embodiment of the present disclosure, the power supply device is configured to provide a constant voltage equal to the turn-on voltage required to light the electroluminescent device at the predetermined temperature to the electroluminescent device.

In an exemplary embodiment of the present disclosure, the turn-on voltage of the electroluminescent device linearly decreases as a temperature increases in a case that the temperature falls within a predetermined temperature range including the predetermined temperature.

In an exemplary embodiment of the present disclosure, the electroluminescent device includes: an anode, a cathode, and an organic light-emitting functional layer located between the anode and the cathode; wherein the anode and the cathode are coupled to the power supply device via wires respectively and form a closed loop with the power supply device.

In an exemplary embodiment of the present disclosure, the temperature sensor includes a plurality of electroluminescent devices, wherein a pattern of a light-emitting area formed by the plurality of electroluminescent devices is set to be a pattern of a number equal to a value of the predetermined temperature plus a corresponding measurement unit for measuring a temperature.

In an exemplary embodiment of the present disclosure, the power supply device includes a DC power supply.

An embodiment of the present disclosure provides a temperature monitoring device, including at least one above-mentioned temperature sensor provided by the embodiment of the present disclosure.

In an exemplary embodiment of the present disclosure, the temperature monitoring device includes a plurality of above-mentioned temperature sensors, and different temperature sensors correspond to different predetermined temperatures.

In an exemplary embodiment of the present disclosure, luminous colors of the different temperature sensors are set to be same as each other.

In an exemplary embodiment of the present disclosure, luminous colors of the different temperature sensors are set to be different from each other.

An embodiment of the present disclosure provides a temperature monitoring method, including: placing the above-mentioned temperature monitoring device provided by the embodiment of the present disclosure in an environment to be monitored; determining whether the temperature sensor emits light or not; and in response to the temperature sensor emitting light, determining whether a temperature of the environment to be monitored reaches a predetermined temperature of the temperature sensor or not according to the temperature sensor that emits light.

In an exemplary embodiment of the present disclosure, the temperature monitoring device includes one temperature sensor; and the in response to the temperature sensor emitting light, determining a temperature of the environment to be monitored according to the temperature sensor that emits light, comprises: in response to the temperature sensor emitting light, determining that the temperature of the environment to be monitored is not less than the predetermined temperature of the temperature sensor.

In an exemplary embodiment of the present disclosure, the temperature monitoring device includes a plurality of above-mentioned temperature sensors; and the in response to the temperature sensor emitting light, determining a temperature of the environment to be monitored according to the temperature sensor that emits light, comprises: by determining a temperature sensor that emits light later than other temperature sensors among the plurality of temperature sensors that currently emit light, determining that the temperature of the environment to be monitored is not less than the predetermined temperature of the temperature sensor that emits light later than other temperature sensors.

### BRIEF DESCRIPTION OF THE DRAWINGS

By reading the detailed description of the non-limiting embodiments with reference to the following drawings, other features, purposes and advantages of the embodiments of the present disclosure will become more apparent. In order to more clearly explain the technical solutions in the embodiments of the present disclosure, the drawings required in the description of the embodiments will be briefly introduced below. Obviously, the drawings in the following description are only some embodiments of the present disclosure. For those ordinary skilled in the art, other drawings can be obtained based on these drawings without paying any creative work. The above and/or additional aspects and advantages of the embodiments of the present disclosure will become apparent and easy to understand from the following description of the embodiments in combination with the drawings, in which:

FIG. 1 shows a schematic diagram of a temperature sensor provided by an embodiment of the present disclosure;

FIG. 2 shows a schematic diagram of another temperature sensor provided by an embodiment of the present disclosure;

FIG. 3 shows a schematic diagram of a relationship between a temperature and a turn-on voltage of an OLED device provided by an embodiment of the present disclosure;

FIG. 4 shows a schematic diagram of another temperature sensor provided by an embodiment of the present disclosure;

FIG. 5 shows a schematic diagram of a temperature monitoring device provided by an embodiment of the present disclosure;

FIG. 6 shows a schematic diagram of another temperature monitoring device provided by an embodiment of the present disclosure; and

FIG. 7 shows a schematic diagram of a temperature monitoring method provided by an embodiment of the present disclosure.

### DETAILED DESCRIPTION OF EMBODIMENTS

The embodiments of the present disclosure will be further described in detail below with reference to the drawings and embodiments. It can be understood that the embodiments described here are used to explain the present disclosure, but not to limit the present disclosure. In addition, it should be noted that, for ease of description, the parts related to the present disclosure are shown in the drawings. For the sake of clarity, the various parts in the drawings are not drawn to scale. In addition, some well-known parts may not be shown in the drawings.

In the following, many specific details of the embodiments of the present disclosure are described, such as the structures, materials, dimensions, processing technologies of the components, so as to understand the embodiments of the present disclosure more clearly. However, as those skilled in the art can understand, the embodiments of the present disclosure may not be implemented according to these specific details.

The dimensions and shapes of the components in the drawings do not reflect the true scales of the components of the temperature sensor and temperature monitoring device in the embodiments of the present disclosure, and are intended to illustrate the content of the embodiments of the present disclosure.

It should be noted that, in the absence of conflict, the examples in the embodiments of the present disclosure and the features in the embodiments may be combined with each other.

According to a general technical concept of the embodiments of the present disclosure, an aspect of the embodiments of the present disclosure provides a temperature sensor. As shown in FIG. 1, the temperature sensor includes: at least one electroluminescent device 1, and a power supply device or circuit 2 electrically coupled to the electroluminescent device 1. The power supply device or circuit is configured to provide the electroluminescent device with a turn-on voltage of the electroluminescent device at a predetermined temperature.

The temperature sensor provided by the embodiment of the present disclosure includes the electroluminescent device and the power supply device or circuit electrically coupled to the electroluminescent device. The turn-on voltages of the electroluminescent device under different temperature conditions are different, so that the temperature may be monitored by using a corresponding relationship between the turn-on voltage of the electroluminescent device and the temperature. The power supply device or circuit provides the turn-on voltage at the predetermined temperature to the electroluminescent device, so that when the temperature reaches the predetermined temperature, the electroluminescent device is lighted and the temperature sensor emits light, which facilitates the integration of temperature sensing and display functions.

As an example, the power supply device or circuit is further configured to provide a constant voltage, for example, always provide the electroluminescent device with a voltage equal to the turn-on voltage of the electroluminescent device at the predetermined temperature. For example, the power supply device or circuit is a battery that provides a constant voltage.

In an exemplary embodiment of the present disclosure, within a predetermined temperature range including the predetermined temperature, the turn-on voltage of the electroluminescent device linearly decreases as the temperature increases.

In this way, the temperature sensor provided by the embodiment of the present disclosure is used, for example, to monitor an overheat protection temperature. The predetermined temperature is the overheat protection temperature. It is assumed that as long as an actually monitored ambient temperature is within a certain predetermined temperature range including the predetermined temperature, the turn-on voltage of the electroluminescent device always linearly decreases as the temperature increases. Further, when the current ambient temperature is lower than the overheat protection temperature, the turn-on voltage of the electroluminescent device is greater than the voltage provided by the power supply device or circuit, so that the electroluminescent device may not be lighted and the temperature sensor may not emit light. When the current ambient temperature increases to the overheat protection temperature, the turn-on voltage of the electroluminescent device is equal to the voltage provided by the power supply device or circuit, then the electroluminescent device is lighted and the temperature sensor emits light, so as to give a warning when the ambient temperature reaches the overheat protection temperature.

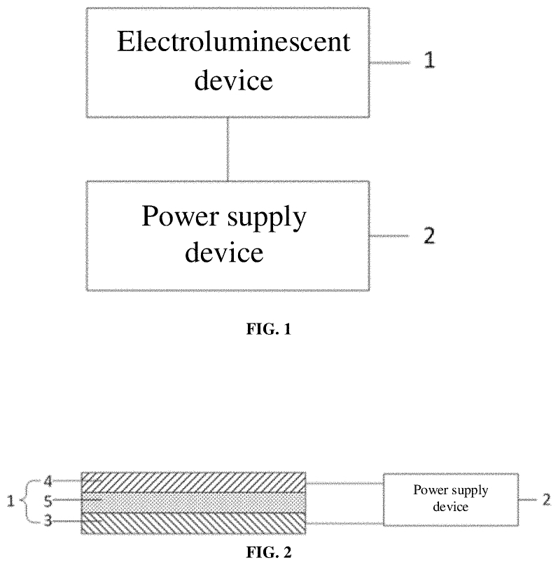

In an exemplary embodiment of the present disclosure, as shown in FIG. 2, the electroluminescent device 1 includes: an anode 3, a cathode 4, and an organic light-emitting functional layer 5 located between the anode 3 and the cathode 4. The anode 3 and the cathode 4 are coupled to the power supply device or circuit 2 via respective wires, so that the anode 3, the organic light-emitting functional layer 5, the cathode 4, and the power supply device or circuit 2 together form a closed loop.

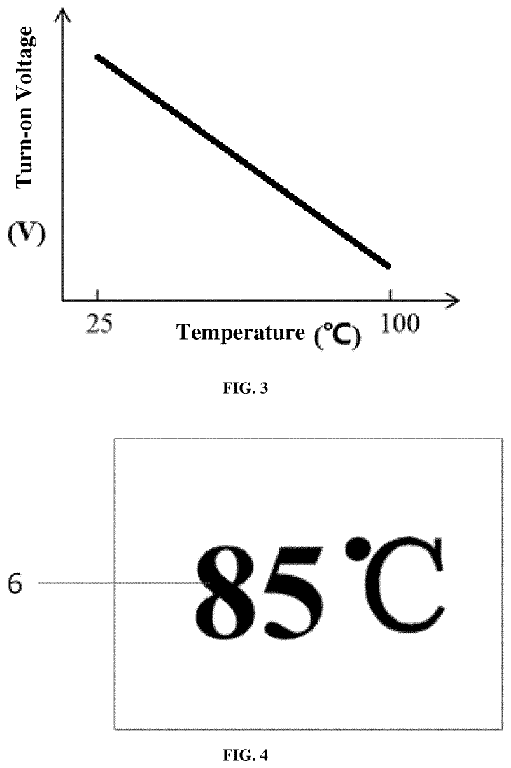

In other words, the electroluminescent device in the temperature sensor provided by the embodiment of the present disclosure is an organic light-emitting diode (OLED) device. A main mechanism of an injection of carriers from the anode and the cathode to the organic light-emitting functional layer of the OLED device is a hot electron injection. Therefore the temperature has a great influence on the carrier injection current. The injection current increases as the temperature increases. At the same time, a mobility of an organic material in the organic light-emitting functional layer is also significantly affected by changes in the temperature. The increase of temperature may enable the carriers to overcome the moving barrier and activate the carrier transport, which leads to an increase in carrier mobility. Therefore, as the temperature increases, the turn-on voltage required to light the electroluminescent device 1 decreases. The effect of the temperature on the carrier injection and carrier mobility of the OLED device is macroscopically expressed as the effect of the temperature on the turn-on voltage. As shown in FIG. 3, the relationship between the turn-on voltage of the OLED device and the temperature exhibits a negative temperature effect, that is, a value of the turn-on voltage of the OLED device linearly decreases as the temperature increases. Further, the turn-on voltage of the OLED device decreases linearly with the increase of temperature in the temperature range of −40° C. to 100° C., which is a wide range of temperature that exhibits the negative temperature effect, thereby satisfying the need for monitoring various overheat protection temperatures.

It should be noted that, for example, by changing the material, thickness, or doping ratio of the organic light-emitting functional layer of the OLED device, the OLED device that may be lighted at different predetermined temperatures is obtained.

In an exemplary embodiment of the present disclosure, the temperature sensor includes a plurality of electroluminescent devices. A pattern of a light-emitting area formed by the plurality of electroluminescent devices is a pattern of the number of the predetermined temperature.

The pattern of the light-emitting area formed by the electroluminescent devices, for example, is set to be a pattern of a number equal to the value of the predetermined temperature plus a corresponding measurement unit for measuring temperature (for example, ° C. or ° F.). When the ambient temperature does not reach the predetermined temperature, the turn-on voltage required to light the electroluminescent device is greater than the voltage actually provided by the power supply device or circuit, so that the electroluminescent device may not be lighted, and the light-emitting area of the temperature sensor may not emit light. When the current ambient temperature increases to the overheat protection temperature, the turn-on voltage required to light the electroluminescent device decreases to equal to the voltage actually provided by the power supply device or circuit, so that the electroluminescent device is lighted, and the light-emitting area of the temperature sensor emits light. In this way, it may be intuitively warned that the current temperature has reached the overheat protection temperature based on the pattern of the light-emitting area.

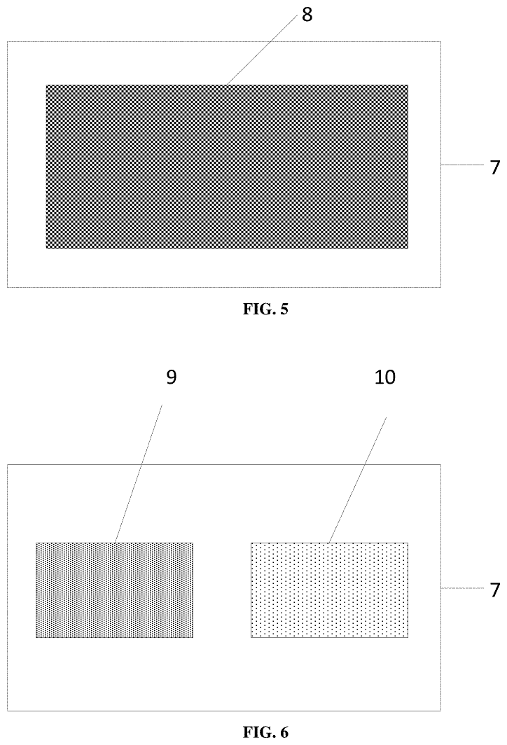

Taking a predetermined temperature of 85° C. as an example, as shown in FIG. 4, in an implementation, a pattern of a light-emitting area 6 formed by the plurality of electroluminescent devices is set to “85° C.”. When the current ambient temperature increases to 85° C., the light-emitting area 6 emits light, and a lighted pattern of “85° C.” is displayed.

In an exemplary embodiment of the present disclosure, the power supply device or circuit includes a DC power supply.

That is, the power supply device or circuit provides a constant voltage signal for the electroluminescent device, so that a voltage difference between the cathode and the anode is a turn-on voltage of the electroluminescent device at the predetermined temperature. When the temperature reaches the predetermined temperature, the electroluminescent device is lighted, and the temperature sensor emits light.

Based on the same concept, another aspect of the embodiments of the present disclosure provides a temperature monitoring device, including at least one above-mentioned temperature sensor provided by the embodiment of the present disclosure.

The temperature monitoring device provided by the embodiment of the present disclosure may be, for example, an electroluminescent display device including the above-mentioned temperature sensor provided by the embodiment of the present disclosure. In a case that the temperature monitoring device is used to monitor an overheat protection temperature, when the electroluminescent display device turns off the screen, it means that the current temperature does not reach the predetermined temperature, that is, the overheat protection temperature. When the display area of the electroluminescent display device emits light, it means that the current temperature has reached the predetermined temperature, that is, the overheat protection temperature. In this way, a user may determine whether the current temperature reaches the overheat protection temperature or not, based on whether the light-emitting area of the temperature monitoring device emits light or not.

As shown in FIG. 5, a temperature monitoring device 7 provided by the embodiment of the present disclosure includes a temperature sensor 8. When the temperature reaches the predetermined temperature, the turn-on voltage required to light the electroluminescent device decreases to equal to the constant voltage actually provided by the power supply device or circuit, so that the electroluminescent device is lighted and the temperature sensor 8 emits light, thereby realizing the integration of temperature sensing and display functions.

In an exemplary embodiment of the present disclosure, the temperature monitoring device includes, for example, a plurality of above-mentioned temperature sensors each corresponding to a different predetermined temperature. The power supply device or circuit for each of the temperature sensors is configured to provide a constant voltage equal to the turn-on voltage required to light each of the electroluminescent devices at the predetermined temperature.

The temperature monitoring device including two temperature sensors is illustrated as an example of the temperature monitoring device provided in the embodiment of the present disclosure. As shown in FIG. 6, the temperature monitoring device 7 includes a first temperature sensor 9 and a second temperature sensor 10. The first temperature sensor 9 corresponds to a first predetermined temperature, and the second temperature sensor 10 corresponds to a second predetermined temperature, where the first predetermined temperature is less than the second predetermined temperature. The first temperature sensor 9 includes a first power supply device or circuit and at least one first electroluminescent device electrically coupled to the first power supply device or circuit. The first power supply device or circuit is configured to, for example, provide a constant first voltage that is equal to a first turn-on voltage required to light the first electroluminescent device at the first predetermined temperature. The second temperature sensor 10 includes a second power supply device or circuit and at least one second electroluminescent device electrically coupled to the second power supply device or circuit. The second power supply device or circuit is configured to, for example, provide a constant second voltage that is equal to a second turn-on voltage required to light the second electroluminescent device at the second predetermined temperature. In this way, when a temperature increases to the first predetermined temperature, the first turn-on voltage of the first electroluminescent device in the first temperature sensor 9 is equal to the first voltage actually provided by the first power supply device or circuit, so that the first temperature sensor 9 emits light, while the second turn-on voltage of the second electroluminescent device in the second temperature sensor 10 is greater than the second voltage actually provided by the second power supply device or circuit (that is, the second turn-on voltage of the second electroluminescent device in the second temperature sensor 10 has not decreased to equal to a voltage actually provided by the second power supply device or circuit), so that the second temperature sensor 10 does not emit light. That is to say, when a temperature increases to the first predetermined temperature, the first temperature sensor 9 emits light and the second temperature sensor 10 does not emit light. When the temperature continues to increase, if the current temperature is greater than the first predetermined temperature and less than the second predetermined temperature, the first turn-on voltage of the first electroluminescent device in the first temperature sensor 9 continues to decrease to less than the first voltage actually provided by the first power supply device or circuit, so that the first temperature sensor 9 keeps emitting light, while the second turn-on voltage of the second electroluminescent device in the second temperature sensor 10 is greater than the second voltage actually provided by the second power supply device or circuit, so that the second temperature sensor 10 does not emit light yet. When the temperature continues to increase to the second predetermined temperature, the first turn-on voltage of the first electroluminescent device in the first temperature sensor 9 continues to decrease, that is, the first turn-on voltage is still lower than the first voltage actually provided by the first power supply device or circuit, so that the first temperature sensor 9 keeps emitting light, while the second turn-on voltage of the second electroluminescent device in the second temperature sensor 10 is equal to the second voltage actually provided by the second power supply device or circuit, so that the second temperature sensor 10 emits light. That is, when the temperature increases to the second predetermined temperature, the first temperature sensor 9 keeps emitting light, and the second temperature sensor 10 starts emitting light. Therefore, a warning of the ambient temperature may be given based on the light-emitting conditions of the first temperature sensor and the second temperature sensor.

In an exemplary embodiment of the present disclosure for example, luminous colors of different temperature sensors are set to be the same as each other.

In an exemplary embodiment of the present disclosure, for example, luminous colors of different temperature sensors are set to be different from each other.

In this way, the temperature range of the current environment may be determined intuitively according to the luminous colors.

In an exemplary embodiment of the present disclosure, the luminous color of the temperature sensor is, for example, red, blue, or green.

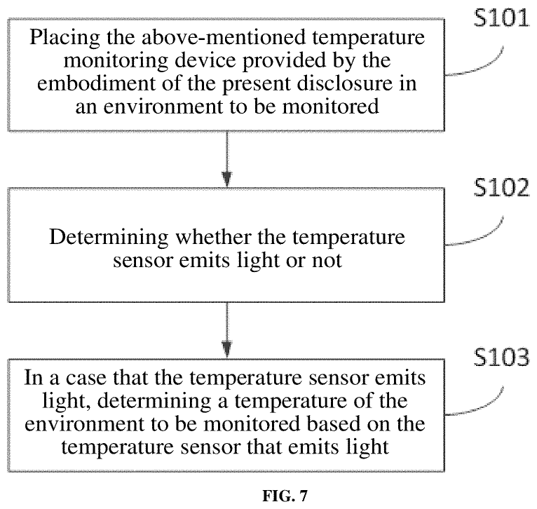

Based on the same concept, another aspect of the embodiments of the present disclosure provides a temperature monitoring method. As shown in FIG. 7, the method includes:

S101: placing the above-mentioned temperature monitoring device provided by the embodiment of the present disclosure in an environment to be monitored;

S102: determining whether the temperature sensor emits light or not;

S103: in a case that the temperature sensor emits light, determining whether a temperature of the environment to be monitored reaches a predetermined temperature of the temperature sensor or not, based on the temperature sensor that emits light.

The temperature monitoring method provided by the embodiment of the present disclosure uses the temperature monitoring device provided in the embodiment of the present disclosure to monitor the ambient temperature, so as to realize the integration of temperature sensing and display functions.

In an exemplary embodiment of the present disclosure, the temperature monitoring device includes, for example, one above-mentioned temperature sensor. The in a case that the temperature sensor emits light, determining a temperature of the environment to be monitored based on the temperature sensor that emits light, includes: in a case that the temperature sensor emits light, determining that a temperature of the environment to be monitored is not less than a predetermined temperature of the temperature sensor.

When the temperature sensor does not emit light, it is determined that the current temperature does not reach the predetermined temperature, that is, the overheat protection temperature. If the ambient temperature increases to the predetermined temperature, the turn-on voltage of the electroluminescent device in the temperature sensor accordingly decreases to equal to the constant voltage provided by the power supply device or circuit, so that the temperature sensor emits light. If the ambient temperature continues to increase to exceed the predetermined temperature, the turn-on voltage of the electroluminescent device in the temperature sensor continues to decrease to less than the voltage provided by the power supply device or the circuit, so that the temperature sensor still keeps emitting light. Therefore, when the temperature sensor emits light, it is determined that the temperature of the environment to be monitored is not less than (that is, equal to or greater than) the predetermined temperature.

When the temperature sensor emits light, it is determined that the current temperature reaches the predetermined temperature, that is, the overheat protection temperature. In this way, the user may determine whether the current temperature reaches the overheat protection temperature or not, based on whether the light-emitting area of the temperature monitoring device emits light or not.

In an exemplary alternative embodiment of the present disclosure, the temperature monitoring device includes, for example, a plurality of above-mentioned temperature sensors. The in a case that the temperature sensor emits light, determining a temperature of the environment to be monitored based on the temperature sensor that emits light, includes: by determining the temperature sensor that emits light later than other temperature sensors among the temperature sensors that currently emit light, determining that the temperature of the environment to be monitored is not less than the predetermined temperature of the temperature sensor that emits light later than other temperature sensors.

For example, the temperature monitoring device includes a first temperature sensor and a second temperature sensor. The first temperature sensor corresponds to a first predetermined temperature, and the second temperature sensor corresponds to a second predetermined temperature, where the first predetermined temperature is less than the second predetermined temperature. The first temperature sensor includes a first power supply device or circuit and at least one first electroluminescent device electrically coupled to the first power supply device or circuit. The first power supply device or circuit is configured to, for example, provide a constant first voltage that is equal to a first turn-on voltage required to light the first electroluminescent device at the first predetermined temperature. The second temperature sensor includes a second power supply device or circuit and at least one second electroluminescent device electrically coupled to the second power supply device or circuit. The second power supply device or circuit is configured to, for example, provide a constant second voltage that is equal to a second turn-on voltage required to light the second electroluminescent device at the second predetermined temperature. If a temperature of the environment to be monitored is less than the first predetermined temperature, neither the first temperature sensor nor the second temperature sensor emits light. If a temperature of the environment to be monitored is greater than or equal to the first predetermined temperature and less than the second predetermined temperature, the first temperature sensor emits light and the second temperature sensor does not emit light. If a temperature of the environment to be monitored is greater than or equal to the second predetermined temperature, both the first temperature sensor and the second temperature sensor emit light.

Compared with the related art, based on the above-mentioned technical solutions, the temperature sensor, temperature monitoring method and temperature monitoring device provided by the embodiments of the present disclosure have at least the following superior technical effects.

In summary, in the temperature sensor, temperature monitoring method and temperature monitoring device provided by the embodiments of the present disclosure, the temperature sensor includes the electroluminescent device and the power supply device or circuit electrically coupled to the electroluminescent device, and the turn-on voltages required to light the electroluminescent device are different at different temperatures, thus the temperature may be monitored by using the corresponding relationship between the turn-on voltage of the electroluminescent device and the temperature (that is, the turn-on voltage required to light the electroluminescent device decreases as the temperature increases). The power supply device or circuit provides the electroluminescent device with the constant voltage that is equal to the turn-on voltage required to light the electroluminescent device at the predetermined temperature, so that when the temperature reaches the predetermined temperature, the electroluminescent device is lighted and the temperature sensor emits light, thereby realizing the integration of temperature sensing and display functions.

Obviously, those skilled in the art may make various modifications and variations to the embodiments of the present disclosure without departing from the spirit and scope of the disclosure. In this way, if these modifications and variations of the embodiments of the present disclosure fall within the scope of the claims of the present disclosure and their equivalent technologies, the present disclosure is also intended to include these modifications and variations.

1. A temperature sensor, comprising:
at least one electroluminescent device; and
a power supply device electrically coupled to the electroluminescent device,
wherein the power supply device is configured to provide a turn-on voltage of the electroluminescent device at a predetermined temperature to the electroluminescent device.

2. The temperature sensor according to claim 1, wherein the power supply device is configured to provide a constant voltage equal to the turn-on voltage required to light the electroluminescent device at the predetermined temperature to the electroluminescent device.

3. The temperature sensor according to claim 1, wherein the turn-on voltage of the electroluminescent device linearly decreases as a temperature increases in a case that the temperature falls within a predetermined temperature range including the predetermined temperature.

4. The temperature sensor according to claim 1, wherein the electroluminescent device comprises: an anode, a cathode, and an organic light-emitting functional layer located between the anode and the cathode; and
wherein the anode and the cathode are coupled to the power supply device via wires respectively and form a closed loop with the power supply device.

5. The temperature sensor according to claim 1, wherein the temperature sensor comprises a plurality of electroluminescent devices, and a pattern of a light-emitting area formed by the plurality of electroluminescent devices is set to be a pattern of a number equal to a value of the predetermined temperature plus a corresponding measurement unit for measuring a temperature.

6. The temperature sensor according to claim 1, wherein the power supply device comprises a DC power supply.

7. A temperature monitoring device, comprising at least one temperature sensor according to claim 1.

8. The temperature monitoring device according to claim 7, wherein the temperature monitoring device comprises a plurality of the temperature sensors, and different temperature sensors correspond to different predetermined temperatures.

9. The temperature monitoring device according to claim 8, wherein
luminous colors of the different temperature sensors are set to be same as each other.

10. The temperature monitoring device according to claim 8, wherein
luminous colors of the different temperature sensors are set to be different from each other.

11. A temperature monitoring method, comprising:
placing the temperature monitoring device according to claim 7 in an environment to be monitored;
determining whether the temperature sensor emits light or not; and
in response to the temperature sensor emitting light, determining whether a temperature of the environment to be monitored reaches a predetermined temperature of the temperature sensor or not according to the temperature sensor that emits light.

12. The method according to claim 11, wherein the temperature monitoring device comprises one temperature sensor; and the in response to the temperature sensor emitting light, determining a temperature of the environment to be monitored according to the temperature sensor that emits light, comprises:
in response to the temperature sensor emitting light, determining that the temperature of the environment to be monitored is not less than the predetermined temperature of the temperature sensor.

13. The method according to claim 11, wherein the temperature monitoring device comprises a plurality of temperature sensors; and the in response to the temperature sensor emitting light, determining a temperature of the environment to be monitored according to the temperature sensor that emits light, comprises:
by determining a temperature sensor that emits light later than other temperature sensors among the plurality of temperature sensors that currently emit light, determining that the temperature of the environment to be monitored is not less than the predetermined temperature of the temperature sensor that emits light later than other temperature sensors.
